(19) United States
(12) Patent Application Publication
(10) Pub. No.: US 2009/0287368 A1
(43) Pub. Date: Nov. 19, 2009

(54) MOTOR VEHICLE HAVING A DRIVER ASSISTANCE SYSTEM

(75) Inventor: Uwe BONNE, Kriftel (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/464,775

(22) Filed: May 12, 2009

(30) Foreign Application Priority Data
May 13, 2008 (DE) 102008023380.3

(51) Int. Cl. G08G 1/16

(52) U.S. Cl. 701/29

(57) ABSTRACT

A motor vehicle has a driver assistance system for outputting a warning message and/or for engaging in a driving operation, an activity of the driver assistance system occurring if a variable triggering threshold is exceeded. To increase the active and passive traffic safety, further external circumstances, in particular influencing variables which have an influence on the driving behavior, the braking distance, and the skid resistance of the motor vehicle, for example, may be taken into consideration during the driving operation.

### CROSS-REFERENCE TO RELATED APPLICATION

This application claims priority to German Patent Application No. 102008023380.3, filed May 13, 2008, which is incorporated herein by reference in its entirety.

### TECHNICAL FIELD

The invention relates to a motor vehicle having a driver assistance system for outputting a warning message and/or for engaging in driving operation, an activity of the driver assistance system occurring if a variable triggering threshold is exceeded.

### BACKGROUND

Motor vehicles increasingly have driver assistance systems, in order to increase the traffic safety and avoid the occurrence of a potential traffic hazard situation or even a collision. For this purpose, distance sensors are used, inter alia, in order to monitor the distance to motor vehicles traveling ahead and, in the event of excessive proximity, to engage in certain circumstances in the regular driving operation with the aid of a braking intervention or at least output a visual and/or acoustic warning message, in order to alert the driver of this potential hazard situation.

A method of this type for triggering an automatic emergency maneuver of a motor vehicle is known from DE 102 20 567 A1. Furthermore, DE 102 20 782 A1 discloses an emergency system for motor vehicles, using which driving incompetency of the driver of the motor vehicle is recognizable and deceleration of the motor vehicle is then executable down to a standstill. In addition, a method and a device for controlling the brake system of a motor vehicle are known from DE 197 38 690 A1, in which, if a threshold value is exceeded, an automatic braking procedure is triggered, for example, in the event of excessively close approach to a motor vehicle traveling ahead. The threshold value is variably changeable as a function of the spacing to the vehicle traveling ahead and/or its velocity, for example.

Furthermore, an assistance system for motor vehicles may be inferred from DE 10 2004 026 590 A1, using which lane changes may be executed safely, an intervention occurring as a function of driver-adaptive variables. For example, an intervention or a warning message may be output at earliest one hour after the beginning of travel, because it is assumed until then that the driver is still attentive and only later requires support. Furthermore, DE 10 2004 038 734 A1 discloses a method and a device for triggering emergency braking, this emergency braking also being able to be triggered as a function of the surroundings being monitored by sensors and it being checked as to whether the triggered emergency braking would not itself result in an actual hazard situation, for example, due to an approaching trailing road user.

The known motor vehicles having a driver assistance system are disadvantageous in that a spacing and/or a velocity of a motor vehicle traveling ahead can be taken into consideration in the judgment for triggering an activity of the driver assistance system, but further factors, which have an influence on the driving operation of the motor vehicle, have not been taken into consideration up to this point.

It is at least one object of the invention to provide a motor vehicle of the type cited at the beginning, whose active and passive traffic safety is increased by an improved driver assistance system. In addition, other objects, desirable features, and characteristics will become apparent from the subsequent summary and detailed description, and the appended claims, taken in conjunction with the accompanying drawings and this background.

### SUMMARY

The at least one object, other objects, desirable features, and characteristics, are achieved in that further external circumstances, in particular influencing variables which have an influence on the driving behavior, the braking distance, and the skid resistance of the motor vehicle, for example, can be taken into consideration during the driving operation.

In a motor vehicle implemented in this way, further factors are even taken into consideration in the establishment of variable triggering thresholds, the driver assistance system engaging in the driving operation and/or outputting a warning message if these thresholds are exceeded. The further external circumstances comprise all influencing variables which have an influence on the driving behavior, the braking distance, and the skid resistance of the motor vehicle, for example, furthermore, a distance to further road users traveling ahead and the particular vehicle velocities being able to be taken into consideration in a way known per se and described hereafter

The advantage is that an already existing driver assistance system having its sensors and possibly further sensors already provided in the motor vehicle must be modified only slightly in regard to hardware and/or software, in order to take the further external circumstances into consideration when establishing variable triggering thresholds.

In an advantageous embodiment, a static friction coefficient between the wheels of the motor vehicle and the road surface is taken into consideration when establishing the variable triggering thresholds. Of course, in the event of a low static friction coefficient, as on smooth asphalt, the braking distance is significantly lengthened in relation to a road surface having good adhesion, whereby the driver assistance system must engage significantly earlier in the driving operation in possible hazard situations than with a road surface having good adhesion. The static friction coefficient may be derived from various factors. For example, if a windshield wiper is activated, a wet road surface, which requires a longer braking distance, may be concluded immediately by the driver assistance system. The slip of the particular wheels may also be checked during acceleration or braking or during cornering and the static friction coefficient of the road surface may be concluded there from. Information in regard to the temperature and/or the wear or the operating time of the tires may also be taken into consideration, because the static friction coefficient decreases with increasing tire age. Information of a navigation system may also be used, in which the fact that the currently traveled road is a gravel road having poor static friction coefficient is stored, for example.

In the same way, in a further embodiment the currently prevailing vision conditions may be taken into consideration when establishing the variable triggering threshold. Reduced visibility may be concluded from an activation, which is also automatic, of a windshield wiper and/or with the aid of information of a rain or fog sensor already provided in the motor vehicle. Furthermore, the time of day may be used to judge the vision conditions during the day and during the night. Driving through tunnels may also be established by sensors, in order to automatically reduce the triggering threshold in the event of vision conditions, which are typically worsened, in tunnels or dark entrances.

According to a refinement, altered deceleration conditions of the motor vehicle may be taken into consideration when establishing variable triggering thresholds. For example, this may be an altered load, which may be established via sensors on the springs and shock absorbers, an increased load resulting in a lengthening of the braking distance. The deceleration conditions are also different on uphill and downhill routes, which may be established by inclination sensors and/or with the aid of the GPS system. A towed trailer and/or information about almost worn-out brake linings may also be taken into consideration.

Furthermore, driver attentiveness may preferably be checked and taken into consideration. Decreased driver attentiveness is assumed, for example, in the event of frequent operation of switches of the sound system and/or the navigation system or if a mobile wireless conversation is performed. Furthermore, conversations in the vehicle interior may be monitored or a breath alcohol concentration measurement may be performed for the driver. In addition, tiredness of the driver may be concluded from the actual driving behavior, if small steering corrections are continuously performed, inter alia. Driver attentiveness may also be presented visually using an image acquisition system, which monitors the eye movements of the driver, for example. Finally, inattentiveness of the driver may be concluded if a lane is not maintained, which may be established by sensors, or if braking reactions occur with a delay in the event of braking maneuvers of motor vehicles traveling ahead.

A traffic density or a traffic volume may expediently also be taken into consideration when establishing the variable triggering thresholds. In a way known per se, distances to other road users traveling ahead and trailing may be ascertained and an increased traffic density may be concluded there from, which requires an increased attentiveness and/or earlier braking in emergency situations. Furthermore, traffic messages, such as TMC messages, in particular about traffic jams, may be taken into consideration. The light signals of traffic lights and/or the presence of specific traffic signs, such as “caution” or “stop”, may also be automatically checked by sensors, in order to trigger a braking maneuver earlier if needed. Pedestrian crossings or pedestrians in the road area lying ahead may also be detected and the triggering threshold may be reduced accordingly.

To increase the subjective acceptance of a variable driver assistance system of this type, according to a further embodiment, the particular level of the triggering threshold may be personalized individually for various drivers. Thus, for example, an inexperienced driver appreciates being notified of all, even only possible hazard situations, whereby acoustic warning signals are frequently output, for example. Another driver feels annoyed by the frequent output of alarm messages, in contrast, and only wants to be warned in cases of absolute emergency, so that he desires a relatively high triggering threshold. These variably settable triggering thresholds may be predetermined by the driver and individually retrieved later, in order to adapt the warning behavior of the driver assistance system to the particular driver.

### BRIEF DESCRIPTION OF THE DRAWING

The present invention will hereinafter be described in conjunction with the following drawing FIGURES, wherein like numerals denote like elements, and the sole FIGURE shows a schematic top view of a motor vehicle according to an embodiment of the invention.

### DETAILED DESCRIPTION

The following detailed description is merely exemplary in nature and is not intended to limit application and uses. Furthermore, there is no intention to be bound by any theory presented in the preceding background or summary or the following detailed description.

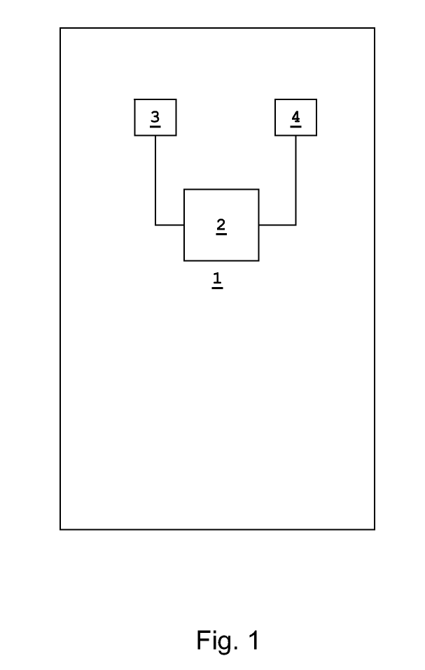

Referring to FIG. 1, the motor vehicle 1 is equipped with a driver assistance system 2, which has one or more sensors 3, using which distances to road users traveling ahead may be checked, for example. If it is established as a function of the vehicle's own velocity and/or the velocity of the road user traveling ahead by the driver assistance system 2, which may be integrated in a central control unit of the motor vehicle 1, for example, that the distance has fallen below a safety distance, either a visual and/or acoustic warning message is output to a driver of the motor vehicle 1 and/or a direct engagement is performed in the regular driving operation, inter alia, by triggering a braking maneuver.

According to an embodiment of the invention, further external circumstances are taken into consideration when establishing these variable triggering thresholds. This may be a static friction coefficient of the road traveled, for example, which has an influence on the braking distance of the motor vehicle 1. The static friction value may be ascertained, inter alia, with the aid of further sensors 4, such as a rain sensor or a temperature sensor, because these two factors have an influence on the static friction coefficient. The sensor 4 may also be a fog or brightness sensor, using which the prevailing vision conditions may be concluded.

The further sensor(s) 4 is/are already provided in the motor vehicle, so that there is hardly any additional outlay in the production of the motor vehicle 1. For example, driver attentiveness may also be ascertained using the further sensors 4, in order to output a request for braking earlier in the event of tiredness or low driver attentiveness.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle, comprising:
a first sensor adapted to sense a distance of a road user from the motor vehicle;
a second sensor adapted to sense an influence on a driving behavior of the motor vehicle; and
a driver assistance system adapted to receive the distance and the influence and initiate an action based on an evaluation of at least the distance and the influence.

2. The motor vehicle according to claim 1, wherein the action comprises generation of a warning.

3. The motor vehicle according to claim 1, wherein the action comprises engaging a driving operation.

4. The motor vehicle according to claim 1, wherein at least the distance and the influence are used to select a variable triggering threshold and the evaluation comprises a comparison to determine if the variable triggering threshold is exceeded.

5. The motor vehicle according to claim 1, wherein the influence comprises a braking distance of the motor vehicle.

6. The motor vehicle according to claim 1, wherein the influence comprises a skid resistance of the motor vehicle.

7. The motor vehicle according to claim 1, wherein the influence comprises a static friction value between a wheel of the motor vehicle and a road surface.

8. The motor vehicle according to claim 7, wherein the static friction value is ascertained based at least in part on information comprising a basis of a slip of the wheel.

9. The motor vehicle according to claim 7, wherein the static friction value is ascertained based at least in part on information comprising a temperature of the motor vehicle.

10. The motor vehicle according to claim 7, wherein the static friction value is ascertained based at least in part on information comprising a wear of the motor vehicle.

11. The motor vehicle according to claim 7, wherein the static friction value is ascertained based at least in part on information comprising an operating time of a tire of the motor vehicle.

12. The motor vehicle according to claim 7, wherein the static friction value is ascertained based at least in part on information comprising navigation system information of the motor vehicle.

13. The motor vehicle according to claim 1, wherein the influence comprises vision conditions.

14. The motor vehicle according to claim 1, wherein the influence comprises information from a rain sensor.

15. The motor vehicle according to claim 1, wherein the influence comprises information from a fog sensor of the motor vehicle.

16. The motor vehicle according to claim 1, wherein the influence comprises an altered deceleration condition.

17. The motor vehicle according to claim 1, wherein the influence comprises a presence of a trailer.

18. The motor vehicle according to claim 1, wherein the influence comprises driver attentiveness.

19. The motor vehicle according to claim 1, wherein the influence comprises a traffic density.
